(19) United States
(12) Patent Application Publication
(10) Pub. No.: US 2006/0260638 A1
(43) Pub. Date: Nov. 23, 2006

(54) Method and system for processing substrates with sonic energy that reduces or eliminates damage to semiconductor devices

(76) Inventors: Pejman Fani, San Diego, CA (US); Ismail Kashkoush, Orefield, PA (US); John Korbler, Mertztown, PA (US); Vivek Vohra, Upper Macungie, PA (US); Alan Walter, Chester Springs, PA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/370,361

(22) Filed: Mar. 8, 2006

Related U.S. Application Data
(60) Provisional application No. 60/659,566, filed on Mar. 8, 2005.
(60) Provisional application No. 60/660,507, filed on Mar. 10, 2005.

(51) Int. Cl. B08B 3/12; B08B 7/00

(52) U.S. Cl. 134/1; 134/33

(57) ABSTRACT

A system and method for processing and/or cleaning substrates using sonic energy that eliminates or reduces damage to the substrates. In one aspect, the invention utilizes and produces low power density sonic energy to effectively remove particles from a substrate. In another aspect, the invention utilizes and generates a clean electrical signal for driving a source of sonic energy, such as a transducer.

### CROSS REFERENCE TO RELATED PATENT APPLICATIONS

The present application claims the benefit of U.S. Provisional Patent Application 60/659,566, filed Mar. 8, 2005 and U.S. Provisional Patent Application 60/660,507, filed Mar. 10, 2005, the entireties of which are hereby incorporated by reference.

### FIELD OF THE INVENTION

The present invention relates generally to the field of processing substrates, and specifically to systems and methods of cleaning semiconductor wafers using sonic/acoustic energy that reduces and/or eliminates damage to semiconductor devices on the wafers.

### BACKGROUND OF THE INVENTION

In the field of semiconductor manufacturing, it has been recognized since the beginning of the industry that removing particles from semiconductor wafers during the manufacturing process is a critical requirement to producing quality profitable wafers. While many different systems and methods have been developed over the years to remove particles from semiconductor wafers, many of these systems and methods are undesirable because they damage the wafers. Thus, the removal of particles from wafers, which is often measured in terms of the particle removal efficiency (“PRE”), must be balanced against the amount of damage caused to the wafers by the cleaning method and/or system. It is therefore desirable for a cleaning method or system to be able to break particles free from the delicate semiconductor wafer without resulting in damage to the devices on the wafer surface.

Existing techniques for freeing the particles from the surface of a semiconductor wafer utilize a combination of chemical and mechanical processes. One typical cleaning chemistry used in the art is standard clean 1 (“SC1”), which is a mixture of ammonium hydroxide, hydrogen peroxide, and water. SC1 oxidizes and etches the surface of the wafer. This etching process, known as undercutting, reduces the physical contact area of the wafer surface to which the particle is bound, thus facilitating ease of removal. However, a mechanical process is still required to actually remove the particle from the wafer surface.

For larger particles and for larger devices, scrubbers have historically been used to physically brush the particle off the surface of the wafer. However, as device sizes shrank in size, scrubbers and other forms of physical cleaning became inadequate because their physical contact with the wafers began to cause catastrophic damage to the smaller/miniaturized devices.

Recently, the application of sonic/acoustic energy to the wafers during chemical processing has replaced physical scrubbing to effectuate particle removal. The sonic energy used in substrate processing is generated via a source of sonic energy, which typically comprises a transducer which is made of piezoelectric crystal. In operation, the transducer is coupled to a power source (i.e. a source of electrical energy). An electrical energy signal (i.e. electricity) is supplied to the transducer. The transducer converts this electrical energy signal into vibrational mechanical energy (i.e. sonic/acoustic energy) which is then transmitted to the substrate(s) being processed. Characteristics of the electrical energy signal supplied to the transducer from the power source dictate the characteristics of the sonic energy generated by the transducer. For example, increasing the frequency and/or power of the electrical energy signal will increase the frequency and/or power of the sonic energy being generated by the transducer.

The relationship between the power level of the sonic energy and particle removal is well known. In essence, higher sonic energy power levels are more effective at removing particles, thus generally resulting in increased PRE. Today, sonic system designs focus on the higher sonic energy power to increase their cleaning effectiveness. Sonic energy has proven to be an effective way to remove particles, but as with any mechanical process, damage is possible and sonic cleaning is faced with the same damage issues as traditional physical cleaning methods and apparatus.

To improve cleaning and to reduce damage caused to wafers by the application of sonic energy, sonic energy equipment suppliers have implemented some solutions that control the frequency of the sonic energy, the amplitude of the sonic energy, and/or the angles at which the sonic energy is applied to the wafers. However, even with these controls, damage is still occurring.

### SUMMARY OF THE INVENTION

It is therefore an object of the present invention to provide a system and method of processing and/or cleaning substrates using sonic energy that reduces and/or eliminates damage to devices on the substrates.

Another object of the present invention is to provide a system and method of processing and/or cleaning substrates using sonic energy that maintains the integrity of a base electrical signal used to power a source of sonic energy.

A further object of the present invention is to provide a system and method of processing and/or cleaning substrates using sonic energy that reduces and/or eliminates spurious content in an electrical signal that is converted to sonic energy.

Yet another object of the present invention to provide a system and method of cleaning substrates using sonic energy that provides effective particle removal from a substrate while reducing the damage caused to the substrate and/or devices thereon.

A further object of the present invention is to provide a system and method of processing and/or cleaning substrates using sonic energy that can adjust the frequency and/or power level of the sonic energy during a particle removal process.

A still further object of the present invention is to provide a system and method of processing and/or cleaning substrates using sonic energy that increases the device yield.

A yet further object is to provide a system and method of supplying power to a sonic energy source that produces low power megasonic energy with minimum noise and distortion.

Another object is to provide a system and method of processing substrates that improves processing efficiency and/or particle removal.

These and other objects are met by the present invention. It has been discovered that the majority of the damage caused to substrates and/or substrate devices during sonic cleaning is due to the sonic energy's excessive power level. The excessive power level is generated either intentionally on a steady state basis (high power) to increase the cleaning efficiency of the process, or unintentionally on a transient basis by the electrical systems of the sonic energy source (i.e. frequency generator, amplifier, transformer, etc). Thus in one embodiment of the invention, in contrast to common practice of using high power to clean the substrate with high efficiency, the steady state sonic energy power level is applied to the substrate at low levels to reduce damage while still facilitating adequate particle removal. The low power level of the sonic energy applied to the substrates during a cleaning process according to the present invention can be measured and/or controlled in terms of power density (which has the units of power/area, e.g., Watts/cm 2).

In some embodiments, the invention can be a method of cleaning substrates comprising: (a) providing a process chamber and a source of sonic energy; (b) supporting a substrate in the process chamber; (c) applying cleaning fluid to at least a first surface of the substrate; (d) creating sonic energy having a power density less than 12.5 Watts per cm 2; and (e) applying the sonic energy to the substrate while applying the cleaning fluid to the first surface for a predetermined time to loosen particles on the first surface. The power density of the sonic energy can be based on the area of the first surface of the substrate, a surface area of the transmitter that is contact with the cleaning fluid, or a coupling area of the transducer.

When power density is based on the surface area of the transmitter coupled to the cleaning fluid, the invention in some embodiments can be a method of cleaning substrates comprising: (a) supporting a substrate in a process chamber; (b) providing a layer of cleaning fluid on a first surface of the substrate; (c) providing a transmitter in contact with the layer of cleaning fluid, the transmitter operably coupled to a transducer, the transmitter having a surface area that is in contact with the layer of cleaning fluid; (d) supplying sonic energy to the transmitter at a power density less than 12.5 Watts per cm 2 of the surface area of the transmitter that is in contact with the layer of cleaning fluid for a predetermined period of time; and (e) the transmitter transmitting the supplied sonic energy through the layer of cleaning fluid and to the substrate, the sonic energy loosening particles on the substrate.

When power density is based on the coupling area of the transducer, the invention in some embodiments can be a method of cleaning substrates comprising: (a) supporting a substrate in a process chamber; (b) providing a cleaning fluid on a first surface of the substrate; (c) providing a transmitter in contact with the cleaning fluid, the transmitter operably coupled to a coupling area of a transducer; (d) supplying electrical energy to the transducer at a power level that results in a power density that is less than 12.5 Watts per cm 2 of the coupling area of the transducer for a predetermined time; (e) the transducer converting the electrical energy into corresponding sonic energy, the sonic energy being transmitted to the transmitter through the coupling area; and (f) transmitting the sonic energy through the cleaning fluid and to the substrate, the sonic energy loosening particles on the substrate.

In some embodiments, the invention can be a system for cleaning substrates comprising: a process chamber having a support for supporting at least one substrate; means for creating an electrical signal; a transducer operably coupled to the signal creation means, the transducer adapted to receive an electrical signal created by the signal creation means and convert said electrical signal into corresponding sonic energy; means for supplying a cleaning fluid to at least a first surface of a substrate positioned on the support; a transmitter operably coupled to the transducer, the transmitter positioned in the process chamber to apply sonic energy created by the transducer to a substrate positioned on the support; a controller operably coupled to the signal creation means, the controller programmed to control the signal creation means so that the electrical signal created results in the corresponding sonic energy having a power density less than 12.5 Watts per cm 2. The controller can be programmed to control the power density of the sonic energy based on the area of the first surface of the substrate, a surface area of the transmitter that is contact with the cleaning fluid, or a coupling area of the transducer.

It has also been discovered that noise/impurities, such as signal distortion and spurious content, present in an electrical signal supplied to the sonic energy source, e.g., a transducer, contributes to the amount of damage to the substrate. Impurities, such as harmonic distortion and other noise, are often introduced into the electrical signal when a base electrical signal is converted into an output electrical signal by an amplifier. The output electrical signal, including its impurities/noise, is transmitted to the transducer and converted into corresponding sonic energy, which also contains the undesirable impurities/noise. It has been discovered that this “noisy” sonic energy increases damage to the substrate. Thus, in another embodiment of the invention, the purity of the electrical signal supplied to the sonic energy source, e.g. the transducer, is controlled in order to reduce the transient changes in the amplitude and/or frequency of the sonic energy being generated.

In some embodiments, the invention can be a method of cleaning substrates comprising: (a) supporting a substrate in a process chamber; (b) providing cleaning fluid on a first surface of the substrate; (c) providing a transmitter in contact with the cleaning fluid, and operably coupled to a transducer, the transducer operably coupled to a signal generator and an amplifier; (d) generating a base electrical signal with the signal generator; (e) transmitting the base electrical signal to the amplifier, the amplifier converting the base electrical signal into an output electrical signal, wherein the amplifier maintains integrity of the base electrical signal so that distortion of the output electrical signal by the amplifier has a ratio of an energy in the harmonic and other noise added by the amplifier to an energy of a fundamental frequency of the base electrical signal in a range of 0.001% to 31%; (f) transmitting the output electrical signal to the transducer, the transducer converting the output electrical signal into sonic energy; and (g) transmitting the sonic energy to the substrate via the transmitter, the sonic energy loosening particles on the first surface of the substrate.

In some embodiments, the invention can be a system for creating sonic energy for use in cleaning substrates comprising: an electrical signal generator; an amplifier operably coupled to the electrical signal generator, the amplifier adapted to receive a base electrical signal generated by the electrical signal generator and convert the base electrical signal into an output electrical signal, wherein the amplifier is further adapted to maintain integrity of the base electrical signal and the output electrical signal has a spurious content of −1 OdBc to −100 dBc of the base electrical signal; and at least one transducer operably coupled to the amplifier, the transducer adapted to receive the output electrical signal from the amplifier and convert the output electrical signal to corresponding sonic energy.

The system can further comprise a process chamber having a substrate support, means for supplying a cleaning fluid to at least one surface of a substrate positioned on the substrate support, and a transmitter operably coupled to the transducer, the transmitter positioned in the process chamber to transmit the sonic energy created by the transducer to a substrate positioned on the substrate support.

### BRIEF DESCRIPTION OF THE DRAWINGS

FIG. 1 is a schematic of a substrate cleaning system according to one embodiment of the invention.

FIG. 2A is a graph displaying clean amplification of a base electrical according to an embodiment of the present invention.

FIG. 2B is a chart of the frequencies present in the amplified output electrical signal of FIG. 2A.

FIG. 3A is a graph displaying prior art amplification of an input electrical signal wherein substantial noise is introduced into the amplified output electrical signal.

FIG. 3B is a chart of the frequencies present in the prior art amplified output electrical signal of FIG. 3A.

FIG. 4 is a graph of Power Output Requested vs. Power Output Delivered for the clean signal generation hardware according to an embodiment of the present invention compared to that of a prior art system.

FIG. 5 is a schematic representation of the elongate probe transmitter of the cleaning system of FIG. 1 in contact with a layer of cleaning fluid on the top surface of a substrate.

FIG. 6 is a perspective view of the elongate probe transmitter of the cleaning system of FIG. 1 separated from the transducer to show a coupling area of the transducer.

FIG. 7 is a graph of particle removal efficiency vs. power for 30 second cleaning cycles according to an embodiment of the present invention.

FIG. 8 is a graph of particle removal efficiency vs. power for 60 second cleaning cycles according to an embodiment of the present invention.

FIG. 9 a bar graph of damage incidents per wafer vs. power for a DIW clean using an elongate probe transmitter cleaning system according to an embodiment of the present invention for less sensitive patterned wafers.

FIG. 10 is a graph of megasonic power vs. damage incidents per wafer for a hot DIW clean using an elongate probe transmitter cleaning system according to an embodiment of the present invention for less sensitive patterned wafers at various frequencies.

FIG. 11 is a schematic of a first alternate embodiment of a transducer/transmitter assembly that can be operated according to the present invention.

FIG. 12 is a schematic of a second alternate embodiment of a transducer/transmitter assembly that can be operated according to the present invention.

FIG. 13 is a schematic of a third alternate embodiment of a transducer/transmitter assembly that can be operated according to the present invention.

FIG. 14 is a schematic of a fourth alternate embodiment of a transducer/transmitter assembly that can be operated according to the present invention.

FIG. 15 is a schematic of a fifth alternate embodiment of a transducer/transmitter assembly that can be operated according to the present invention.

FIG. 16 is a schematic of a sixth alternate embodiment of a transducer/transmitter assembly that can be operated according to the present invention.

FIG. 17 is a schematic of a seventh alternate embodiment of a transducer/transmitter assembly that can be operated according to the present invention.

FIG. 18 is a schematic of an eighth alternate embodiment of a transducer/transmitter assembly that can be operated according to the present invention.

FIG. 19 is a graph of final particle count vs. power achieved in a hot DIW cleaning experiment conducted according to an embodiment of the present invention.

FIG. 20 is a graph of particle removal efficiency vs. power achieved in a hot DIW cleaning experiment conducted according to an embodiment of the present invention.

FIG. 21 is a graph of final particle count vs. power achieved in an ambient dilute SCI solution cleaning experiment conducted according to an embodiment of the present invention.

FIG. 22 is a graph of particle removal efficiency vs. power achieved in an ambient dilute SC I solution cleaning experiment conducted according to an embodiment of the present invention.

FIG. 23 is a graph particle removal efficiency and number of damage sites vs. power for the dilute SCI cleaning experiment.

### DETAILED DESCRIPTION OF THE DRAWINGS

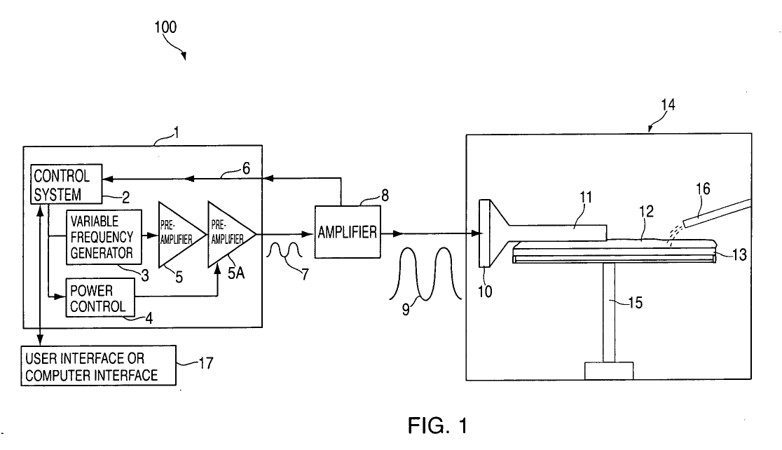

FIG. 1. is a cleaning system 100 according to an embodiment of the present invention. The cleaning system 100 utilizes sonic energy to effectuate the cleaning of a substrate 13. The invention can also be applied to the manufacture of raw wafers, lead frames, medical devices, disks and heads, flat panel displays, microelectronic masks, and other applications requiring levels of cleanliness. The cleaning system 100 is designed to clean substrates, such as semiconductor wafers, with low power density sonic energy. The cleaning system 100 is also designed to reduce noise/impurities, such as signal distortion and spurious content, present in an electrical signal supplied to the sonic energy source, e.g., a transducer 10. By utilizing low power density sonic energy and a clean electrical signal, the cleaning system 100 reduces and/or eliminates damage to the substrate 13 caused by the sonic energy.

The cleaning system 100 comprises a controller 1, an amplifier 8, a transducer 10, a transmitter 11, a process chamber 14, a support 15, a nozzle 16, and a user interface 17. The controller 1 comprises a control system 2, a variable frequency generator 3, a power control unit 4, a pre-amplifier 5, and an attenuator 5A. All of the components of the controller 1 are electrically and operably coupled as illustrated in FIG. 1. The user interface 17 is operbaly coupled to the controller 1 via the control system 2. The amplifier 8 is operbaly coupled to the controller 1 via the attenuator 5A in order to receive a base electrical signal 7. The amplifier 8 is also coupled to the control system 2 in order to transmit data representing forward/reflected power feedback, which is used in power control.

The controller 1 is responsible for generating a base electrical signal 7 via the variable frequency generator 3. During a substrate cleaning operation, a user activates the cleaning system 100 by inputting an activation command into the user interface 17. The activation command may include imported process parameters or may be identifiable by the controller 1 so that stored process parameters are retrieved from a memory device.

The activation command is transmitted to the control system 2 as an activation signal. Upon the control system 2 receiving the activation signal, the control system 2 turns on the variable frequency generator 3, thereby creating a base electrical signal 7. The variable frequency generator 3 can be a Direct Digital Synthesis Chip (DDS Chip). Other methods and hardware of frequency generation are also available, including an independent frequency generator.

The base electrical signal 7 is then transmitted through the pre-amplifier 5 and the attenuator 5A to the amplifier 8. The pre-amplifier 5 and the attenuator 5A provide some fine control over the amplitude of the base electrical signal 7. The base electrical signal 7 is created having a desired frequency. As will be discussed in greater detail below, the variable frequency generator 3 can vary the frequency of the base electrical signal during its creation if desired. This frequency variation can include sweeping or jumping.

The amplifier 8 is used to increase the amplitude (i.e. the power level) of the base electrical signal 7 to a desired value, thereby converting the base electrical signal 7 into an output electrical signal 9. The frequency of the output electrical signal 9 corresponds to the frequency (whether variable or steady) of the base electrical signal 7 at the desired power level. The output electrical signal 9 is transmitted to the transducer 10 via the appropriate electrical connection. The transducer 10 converts the output electrical signal 9 to corresponding sonic energy having the same frequency. This sonic energy is then transmitted to the substrate 13 via the transmitter 11 and a layer of cleaning fluid 12 supplied by the nozzle 16.

It is important that a clean and controlled output electrical signal 9 be supplied to the transducer 10. It has been discovered that noise, spikes, spurious content, and/or high power signals can easily damage devices on the substrate 13. It is preferred that the device side of the substrate 13 be the side to which the transmitter 11 is coupled via the layer of cleaning fluid 12.

The controller 1 is responsible for monitoring and controlling the power level of the output electrical signal 9 delivered to the transducer 10. Tight control of the power level of the output electrical signal 9 is important to prevent damage to the substrate 13 and the equipment itself. The controller 1 has various methods to control the power level of the output electrical signal 9 including: (1) controlling the amplitude output of the frequency generator itself (DDS chip); (2) providing an analog control signal to control the gain of the pre-amplifier 5 for the electrical signal; (3) providing an analog signal to the attenuator 5A (the pre-amplifier 5 typically introduces a fixed gain before the attenuator 5A); (4) providing an analog signal to an attenuator within the amplifier 8; and/or (5) providing an analog signal to the amplifier 8 to adjust the amplifier gain. Preferably, a combination of methods (1) and (3) is used.

The controller 1 monitors the forward and reflected power measurements for feedback to control the power via line 6. This feedback can be supplied by the amplifier 8 via line 6 or from an external Directional Coupler and/or independent voltage and current sensors. The controller 1 will control the power level of the output electrical signal 9 to ensure that it does not exceed a target value in order to prevent potential damage to the substrate 13. As will be discussed below in greater detail, this target value is determined so that the sonic energy being created by the transducer 10 and/or transmitted to the substrate 13 via the transmitter 11 is at or below a desired power density. It is preferred to use a directional coupler incorporated into the amplifier 8 for making these measurements.

The amplifier 8 faithfully reproduces the base electrical signal 7 with a higher power capacity as the output electrical signal 9. The amplifier 8 amplifies the bas electrical signal 7 (i.e., converts the base electrical signal 7 into the output electrical signal 9) while minimizing the addition of noise or spikes (i.e., harmonic distortion and spurious content) to the output electrical signal 9. More specifically, the amplifier 8 converts the base electrical signal 7 into the output electrical signal 9 while maintaining the integrity of the base electrical signal 7 so that any distortion of the output electrical signal 9 introduced by the amplifier 8 has a ratio of an energy in the harmonic and other noise added by the amplifier 8 to an energy content of a fundamental frequency of the base electrical signal 7 in a range of 0.001% to 31%, or within −100 dB to −1 OdB. The ratio can be expressed as:
Ratio (%)=100*(SQRT(EN2+EH22+EH32+ . . . ))!EF
Ratio (dB)=20*log(SQRT(EN2+EH22+EH32+− . . . ))/EF

where:
EN=Energy of the Noise,
EH=Energy of each Harmonic, and
Energy is calculated using equivalent RMS voltage

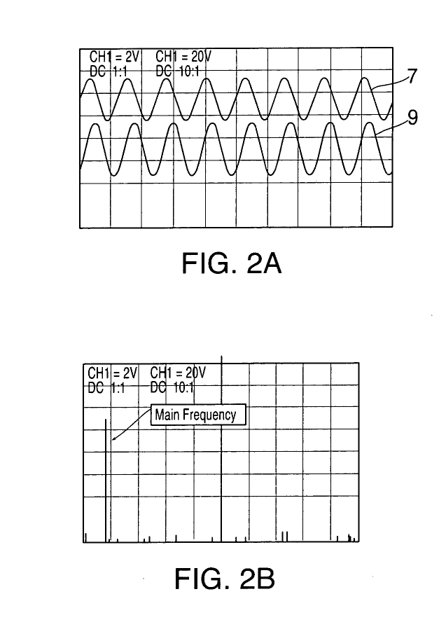

FIGS. 2A and 2B illustrate the cleanliness of the output electrical signal 9 from the amplifier 8 at 25 Watts according to an embodiment of the present invention. FIG. 2A graphs the base electrical signal 7 and the amplified output electrical signal 9, both of which are sine waves. A pure sine wave has only a single frequency component. FIG. 2B charts the frequencies of the output electrical signal 9. As can be seen from the graph of FIG. 2B, very little distortion, noise, and/or spurious content is introduced into the output electrical signal 9 by the amplifier 8. Thus, the amplifier 8 is creating a clean output electrical signal 9 while maintaining the integrity of the base electrical signal 7.

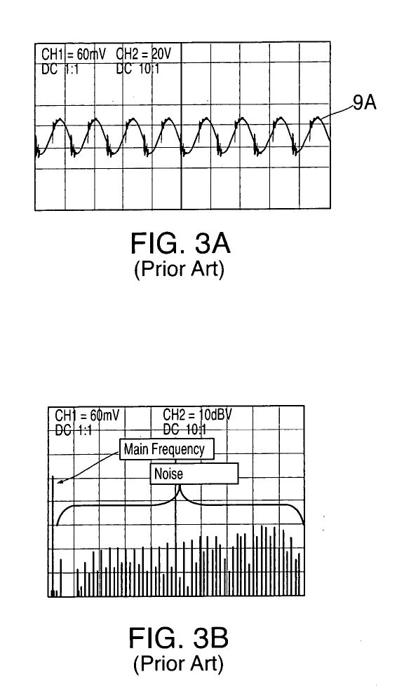

Comparing this to FIGS. 3A and 3B, which illustrates prior art amplification at 12.5 Watts, the difference between a clean amplified sine wave (as shown in FIGS. 2A and 2B) and a lower quality amplifier design is exemplified. The prior art low quality amplifier introduces a substantial amount of noise into the input electrical signal (the input electrical signal is identical to the base electrical signal 7 of FIG. 2A). The output signal 9A contains noise, such as spikes, spurious content, and distortion of the input electrical signal. This noise is measured by the additional frequencies present in the output signal 9A and is graphically displayed in FIG. 3B. In contrast, a clean/pure sine wave would have only a single frequency component.

Referring back to FIG. 1, the amplifier 8 can be a class A or class AB amplifier, such as an AR Kalmus 25A250AM2 amplifier. The amplifier 8 has an internal amplifier brick having a high gain and has a front end attenuator 5A. The amplifier 8 should be selected so that clean output electrical signals can be produced up to at least 25 Watts, and preferably higher. The signal generator 3 can be an HP3312A Arbitrary Waveform Generator or the like.

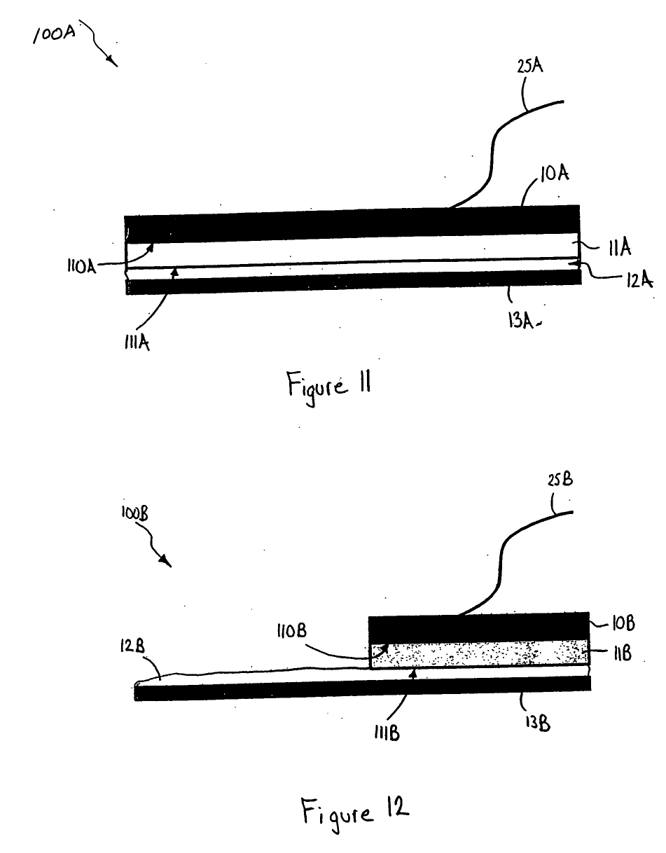

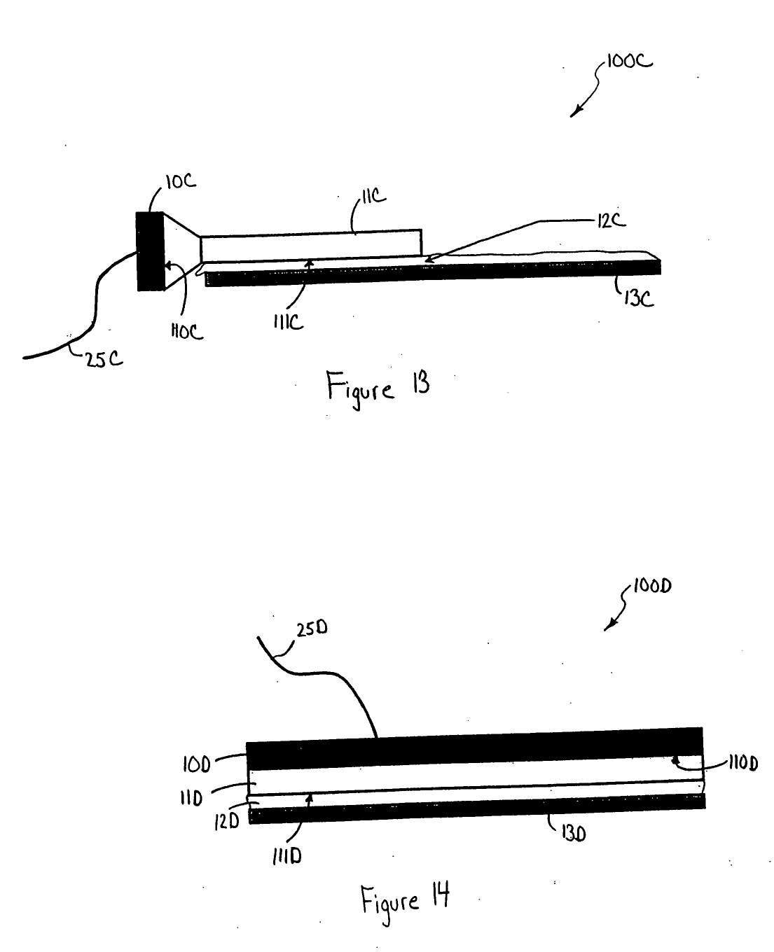

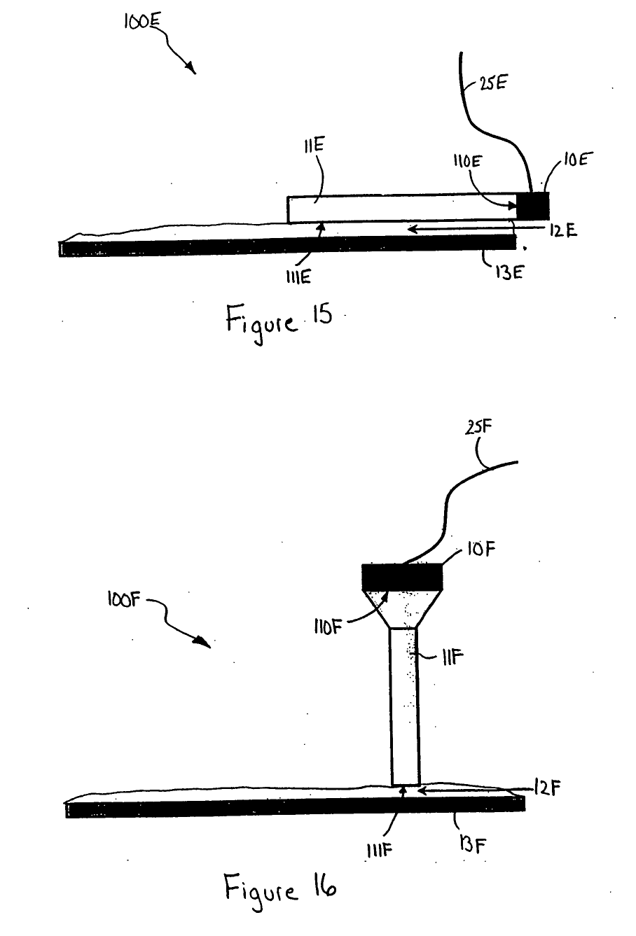

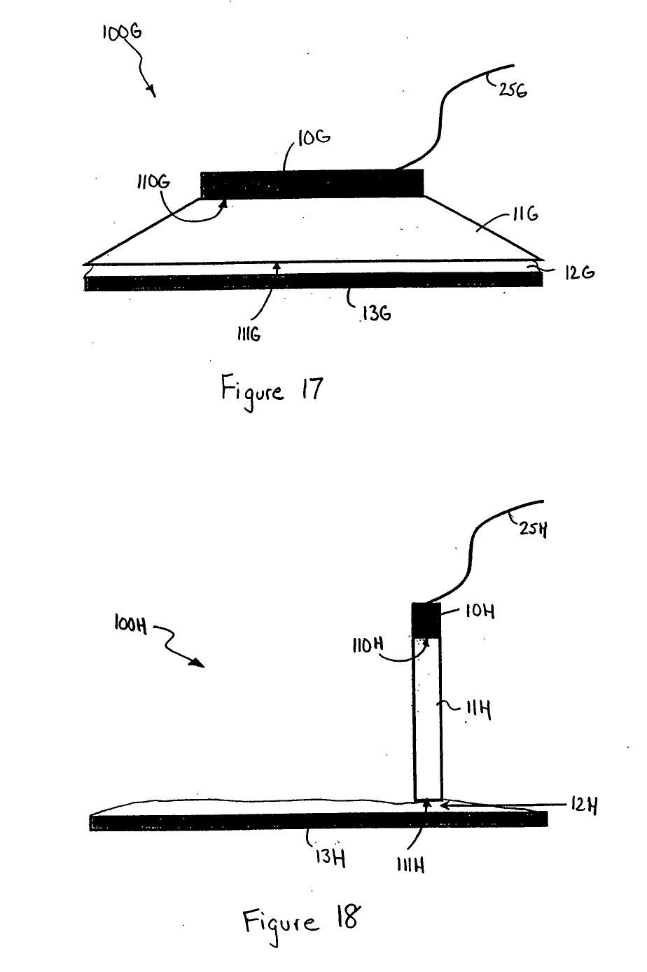

It should be noted that while the hardware used to create the clean output electrical signal 9 is shown in conjunction with an elongate probe transmitter 11, the clean signal generation hardware (i.e., the controller 1 and the amplifier 8) can be used in conjunction with any cleaning system that utilizes sonic energy. For example, the clean signal generation hardware of the present invention can be used with any shaped transmitter or transducer(s), including, without limitation, any of the devices shown in FIGS. 11 to 18.

It is preferred, however, that the transmitter 11 cover less than the entire surface of area of the substrate 13. In one such embodiment, the transmitter will comprises an elongated edge that contacts the layer of cleaning fluid 12. The elongated edge can be a bottom edge of a rod-like probe design or a side edge of a pie-shaped probe device. Relative motion between the substrate 13 and the transmitter 11 is produced so that megasonic energy is applied to the entirety of the substrate's surface. This relative motion can be achieved by rotating the substrate 13, translating the transmitter 11, pivoting the transmitter 11, or a combination thereof.

Moreover, if desired, the clean signal generation hardware can be used in conjunction with batch cleaning systems that submerge a plurality of substrates in a cleaning fluid rather than applying a layer of cleaning fluid to the surface (or surfaces) of a single substrate.

As discussed above, it has been discovered that a majority of the damage caused to substrates and/or substrate devices during sonic energy cleaning is due to the sonic energy's excessive power level, which is generated either intentionally on a steady state basis (high power) to increase the cleaning efficiency of the process, or unintentionally on a transient basis by the electrical systems of the sonic energy source (i.e. frequency generator, amplifier, transformer, etc). As set forth above, the clean signal generation hardware of the cleaning system 100 remedies/minimizes the unintentional production of excessive power levels resulting from the electrical systems of the sonic energy source (i.e. frequency generator, amplifier, transformer, etc). Moreover, the clean signal generation hardware of the cleaning system 100 can also be operated to eliminate or reduce the excessive power levels which are generated intentionally on a steady state basis.

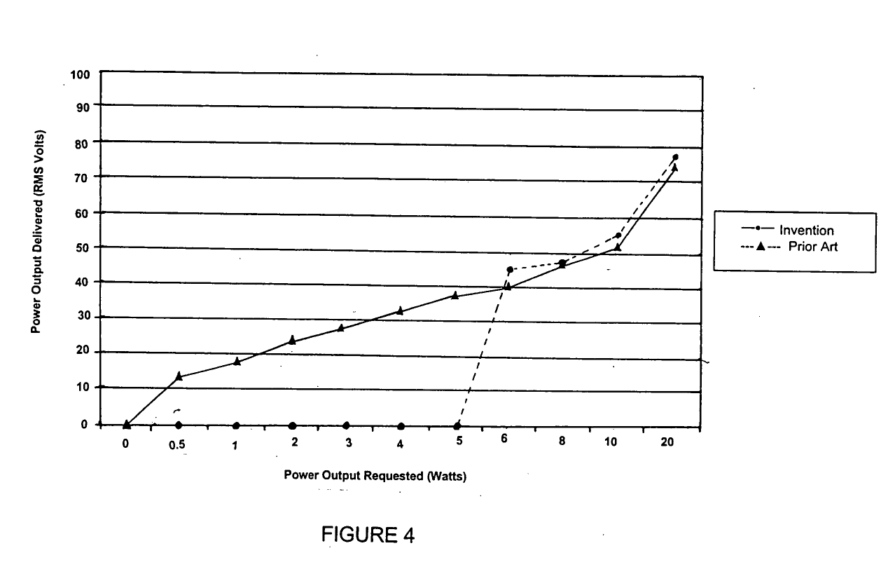

Referring to FIG. 4, the ability of the amplifier 8 of the cleaning system 100 to operate at low power while maintaining a stable output is shown. The inability of prior art amplifiers to operate at low power while maintaining a stable output is also shown in FIG. 4. As can be seen, the clean signal generation hardware of the present invention has a greater ability to operate at power levels less than 20 Watts with stable output than prior art hardware. While the low power cleaning methods of the present invention will be exemplified in relation to the cleaning system 100, those skilled in the art will appreciate that the low power cleaning method is not limited to any specific cleaning system and can be performed by any existing sonic energy cleaning system.

Referring back to FIG. 1, in performing a low power substrate leaning process according to an embodiment of the present invention, a substrate 13 is first positioned within the process chamber 14 on the substrate support 15. The substrate support 15 supports the substrate 13 in a substantially horizontal orientation, preferably with the device side of the substrate 13 face up. In other embodiments, the substrate may be supported in a vertical or angled orientation. The support 15 is coupled to a motor so that the substrate 13 can be rotated during processing.

Once the substrate 13 is supported and being rotated within the process chamber 14, a cleaning fluid is supplied to the top surface of the substrate 13 via the nozzle 16. In some embodiments, the top surface of the substrate 13 preferably will contain semiconductor devices thereon. The nozzle 16 is operably and fluidly coupled to a source of cleaning fluid, such as a reservoir, a mixer, or a bubbler (in the case where the cleaning fluid comprises a dissolved gas). Suitable cleaning fluids include, without limitation, deionized water, gasified deionized water, standard clean 1 (“SC 1”), dilute standard clean 1 (“dSC 1”), dilute ammonia, hydrofluoric acid (“HF”), nitric acid, a mixture of sulfuric acid and a polymer/photoresist stripper, including EKC265, DSP, DSP+, ST22, ST28, ST 255, and ST250. An SCI solution is preferred having a concentration ratio of 1 part NH40H:2 parts H202: x parts H20, where 100<x<500. Most preferably x is about 100. In some embodiments, the cleaning fluid may comprise a dissolved gas, such as ozone or other gases. In other embodiments of the invention, the system can be sued for processes other than traditional cleaning, such as photo-resist stripping, etc.

The SC 1 is applied to the top surface of the substrate 13 via the nozzle 16 so that a layer/meniscus 12 of SC 1 solution forms on the top surface of the substrate 13. The layer 12 of SCI forms a fluid coupling between the top surface of the substrate 13 and the elongated edge of the probe transmitter 11. Optionally, a second nozzle or other source can be provided to simultaneously supply cleaning fluid to the bottom surface of the substrate 13 if desired. It is preferred that the cleaning fluid be at ambient temperature when applied to the substrate surface.

Once the layer 12 of SC 1 is formed on the top surface of the substrate 13, the controller 1 is activated, thereby creating a base electrical signal 7 which is transmitted to the amplifier 8 for conversion to the output electrical signal 9 as discussed above. The output electrical signal 9 is created having a desired frequency and a desired power level (i.e., an amplitude), which is dictated by user preferences/inputs programmed into the control system 2.

The output electrical signal 9 is transmitted to the transducer 10 for conversion into sonic energy. The characteristics of the sonic energy created by the transducer 10, e.g. frequency and power, correspond to the characteristics of the output electrical signal 9 supplied to the transducer 10. The desired frequency of the output electrical signal 9 is preferably chosen so that the sonic energy created by the transducer is within a range of approximately 400 kHz to 5 MHz, and most preferably within a range of 800 kHz to 2 MHz. The optimal frequency for substrate cleaning will be dictated by design considerations and will be determined on a case by case basis. Relevant considerations can include, without limitation: (1) the size of the devices on the substrate; (2) the size of the particles desired to be removed; (3) the desired power level; (4) the cleaning fluid being used; and (5) the processing time and temperatures. As will be discussed below, the power level of the output electrical signal 9 is set so that the sonic energy is created having a desired low power density.

Once the sonic energy is created by the transducer 11, the sonic energy is transmitted by the elongate probe transmitter 11 to the layer 12 of SC1. The sonic energy is then transmitted through the layer 12 of SC1 to the top surface of the substrate 13. The sonic energy loosens particles on the top surface of the substrate 13 which are then carried away by the centrifugal fluidic motion of the layer 12 of SC1. The low power density sonic energy is applied to the substrate 13 for a predetermined period of time during the continued application of the SC1. Preferably, the predetermined time is within the range of 1 to 300 seconds, is more preferably within the range of 20 to 100 seconds, and is most preferably about 30 to 60 seconds.

In order to reduce and/or eliminate damage to the devices on the top surface of the substrate 13, the power density of the sonic energy transmitted to the layer 12 of SC 1 is maintained at or below 12.5 Watts per centimeter squared (“cm²”). In some embodiments, the power density of the sonic energy will be within the range of 0.01 to 12.5 Watts per cm². In other embodiments, the power density will be within the range of 0.01 to 2.5 Watts per Cm² or within the range of 1 to 4 Watts per cm². The optimal power density for any given substrate will be determined on a cases by case basis, considering such factors as device size, susceptibility to damage, allowable damage, cleanliness requirements, etc.

In some embodiments of the present invention, the power density of the sonic energy applied to the substrate 13 via the transmitter 11 is controlled by controlling the power level (i.e. amplitude) of the output electrical signal 9 being generated by the amplifier 8 (and subsequently supplied to the transducer 10). In order for the controller 1 and the amplifier 8 to output an electrical signal 9 that will result in the sonic energy being created (and transmitted to the substrate) having the desired low power density, the power density must be based on a measurable area. Suitable areas that can be used in determining the power level of the output electrical signal 9 that will result in the sonic energy having the desired low power density, include: (1) the area of the top surface of the substrate 13; (2) the area of the transmitter 11 in contact with the layer 12 of SC1; and (3) the area of the transducer 10 coupled to the transmitter 11.

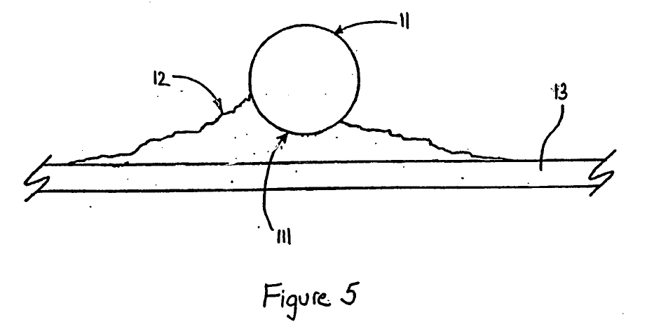

Turning to FIG. 5, the elongate probe transmitter 11 is shown in contact with (i.e., coupled to) the layer 12 of SC 1 on the top surface of the substrate 13. An area 111 of the outside surface of the elongate probe transmitter 11 is coupled to the layer 12 of SC1. The area 111 is known and/or can be measured easily. Once the area 111 is known through experimentation, simulation, or estimation, the area can be used to determine the power level of the output electrical signal 9 to be supplied to the transducer 10. For example, in one embodiment, the area 111 is determined to be about 1.5 cm². As such, an output electrical signal 9 having a power level of 15 Watts is needed to result in the sonic energy having a power density of 10 W/cm² (assuming no dampening or energy loss).

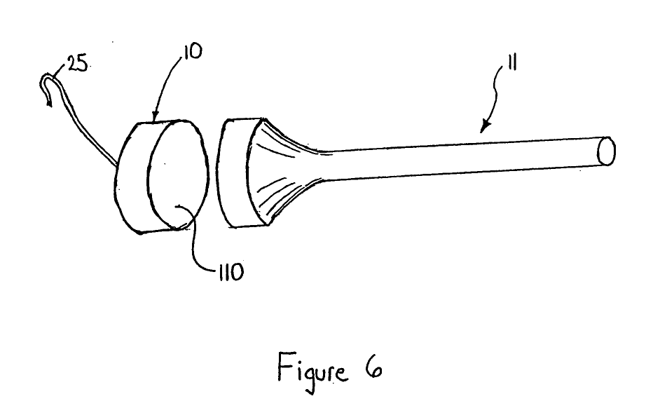

Turning now to FIG. 6, the elongate probe 11 is shown uncoupled from the transducer 10. When assembled for operation, the elongate transmitter is coupled to the coupling area 110 of the transducer 10. A wire 25 is provided in operable connection with the transducer 10 for transmission of the output electrical signal 9. In some embodiments of the invention, it may be desirable to use the coupling area 110 of the transducer 10, rather than the fluidly coupled area 111 of the transmitter 11, to calculate the power value of the output electrical signal 9 needed to create sonic energy having the desired low power density. For example, if the coupling area 110 of the transducer is 10 cm², an output electrical signal 9 having a power level of 15 Watts is needed to result in the sonic energy having a power density of 1.5 W/cm² (assuming no dampening or energy loss between the transducer and the transmitter).

Referring back to FIG. 1, in some embodiments, the surface area of the top surface of the substrate 13 itself can be used to calculate the power value of the output electrical signal 9 needed to create sonic energy having the desired low power density.

Irrespective of what surface area is used to calculate the power level of the output electrical signal 9 that will result in the sonic energy having the desired power density, all values and algorithms needed to perform the necessary calculations, including area, desired power density, and power levels are stored in a memory device of the controller 1 and retrieved when necessary for operation of the system 100 according to the desired parameters.

The cleaning system 100 applies the sonic energy at the desired low power density during application of the SC1 for the predetermined period of time (as discussed above). The power density and predetermined time can be chosen such that at least a certain percentage of particles are removed from the top surface of the substrate 13. In some embodiment, the predetermined time and the power density will be selected so as to remove at least 80% of particles from the top surface of the substrate 13. However, the necessary particle removal efficiency (“PRE”) that must be achieved in a cleaning process for any given substrate will depend on the type of substrate, the size of the devices, etc. Thus, the required PRE can vary greatly.

In one embodiments, it has been determined that wherein the predetermined time is approximately 30 seconds, the power density is approximately 0.2 watts/cm², approximately 80% of particles are removed from the top surface of the substrate using SC1 at ambient temperature.

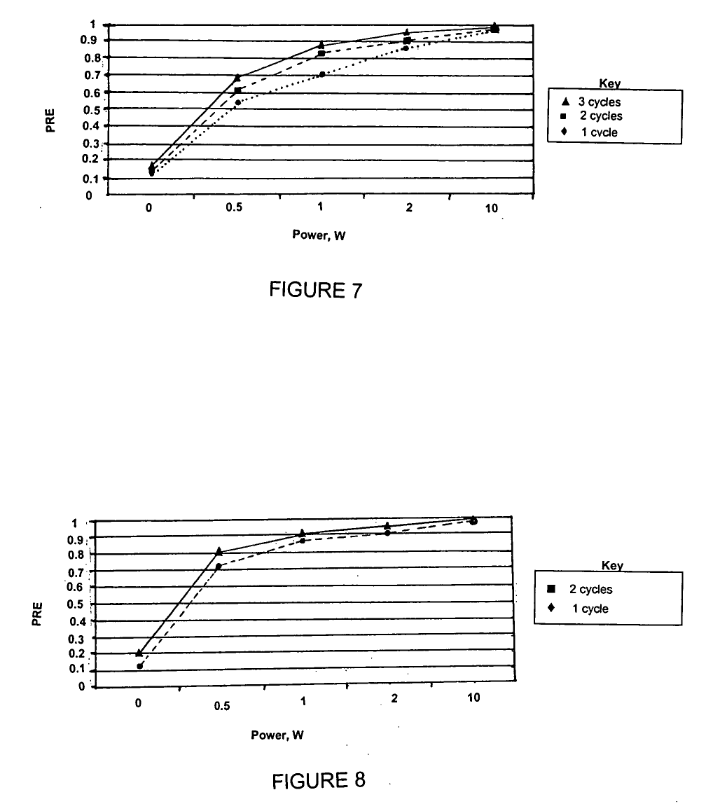

Referring to FIGS. 7 and 8, data is graphed showing the PRE capabilities of the cleaning system 100 when operated at various low power density settings. Ambient SC1 (1:2:100 concentration ratio) was used in collecting the data. The fluidly coupled area of the transmitter was approximately 3.81 cm 2. FIG. 7 graphs the effect on PRE at various power levels when the predetermined time is 30 seconds per cycle. FIG. 7 also illustrates the effect on PRE when the substrates are subjected to 2 and 3 consecutive cleaning cycles of 30 seconds. FIG. 8 is similar to FIG. 7 except that the predetermined time was 60 seconds per cycle.

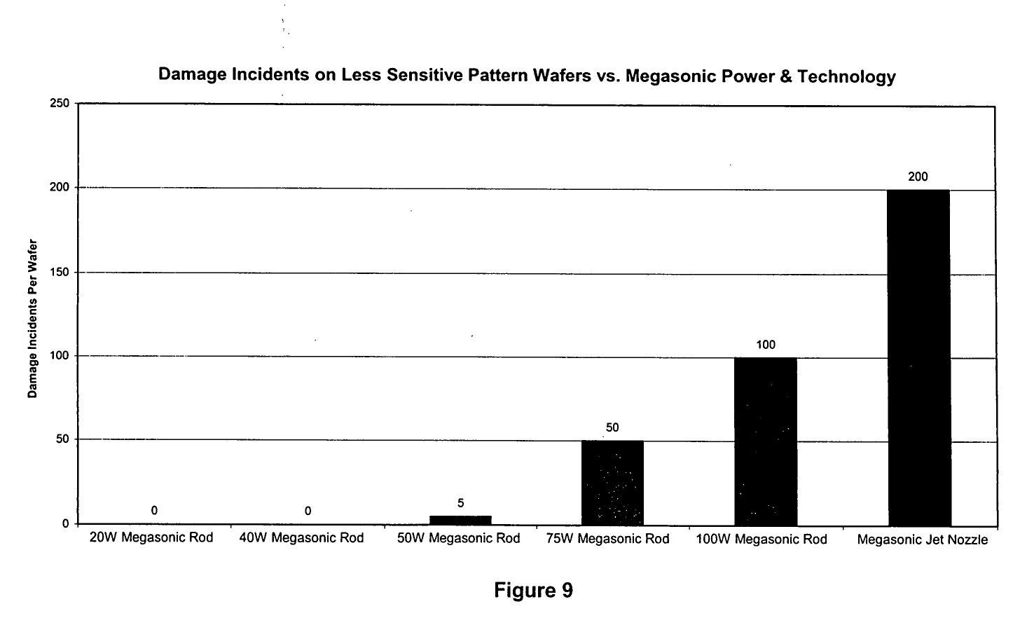

FIG. 9 is a bar graph of damage incidents per wafer vs. power supplied. In collecting the data for FIG. 9, a semiconductor wafer having less sensitive patterns/devices thereon was processed in a megasonic cleaning system similar to that which is shown in FIG. 1 at various power inputs. Ambient DIW was used as the cleaning fluid. Each wafer was processed for 40 seconds. The approximate area of the transmitter that was in contact with the DIW was 3.81 cm². As can be seen from the data, the incidents of damage on the wafer decreased as the power density of the sonic energy applied to the wafer decreased. At 10.5 W per cm² (which corresponded to 40 W megasonic rod/3.81 cm²) and below, zero incidents of damage per wafer was achieved. In comparison, megasonic cleaning using a prior art jet nozzle technique resulted in 200 incidents of damage on the wafer. Thus, low power density megasonic cleaning can eliminate or reduce damage to devices on wafers.

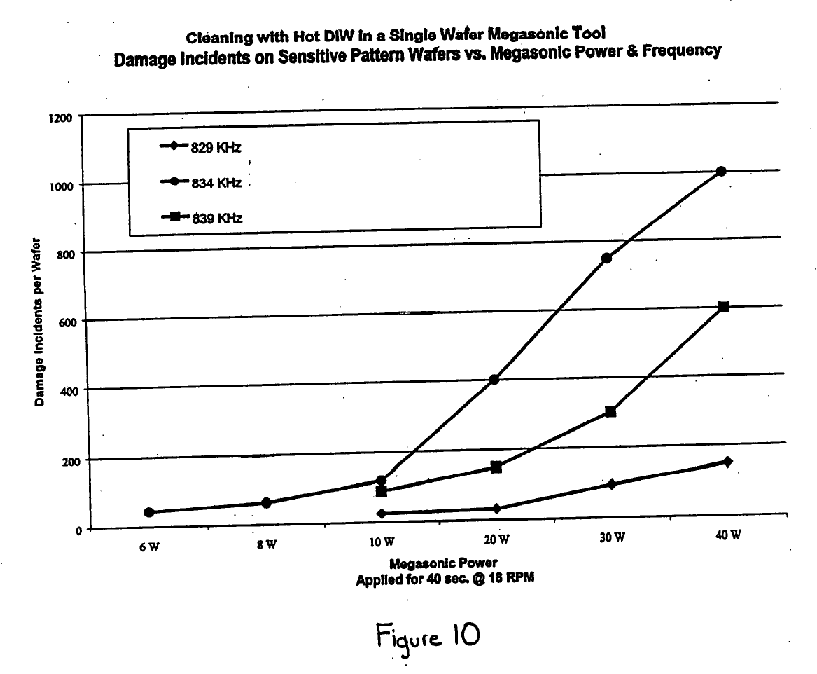

FIG. 10 is a graph of damage incidents per wafer vs. power supplied to the transducer of a cleaning system similar to the system shown in FIG. 1 for various frequencies. DIW at 60° C. was used. The processing time was 40 seconds. The approximate area of the elongate probe transmitter that was in contact with the hot DIW was 3.81 cm². The power (measured on the x-axis) and the frequency are the power and the frequency of the electrical signal supplied to the transducer which is then converted to corresponding sonic energy. As can be seen from the data, both power and variations in frequency play a role in damaging the wafer. Under the aforementioned process conditions, sonic energy having a frequency of 829 KHz resulted in the least amount of damage for sensitive pattered wafers.

It should be noted that the optimal frequency for PRE and/or damage reduction for a specific cleaning process must be determined on a case by case basis, considering such factors as particle size, device size, device sensitivity, power level, and processing time. Generally, the sonic energy should have a frequency within a range of 400 kHz to 5 MHz, and more preferably within a range of 800 kHz to 2 MHz.

Referring back to FIG. 1, in some embodiments of the invention, the frequency of the sonic energy being transmitted to the substrate 13 will be varied during the low power cleaning process of the present invention. This is achieved by varying the frequency of the base electrical signal 7 being generated by the signal generator 3. The amplifier 8 converts the base electrical signal 7 into the output electrical signal 9 so that the output electrical signal 9 has corresponding frequency characteristics. Similarly, the transducer 10 converts the output electrical signal 9 into sonic energy having corresponding frequency characteristics. Thus, varying the frequency of the base electrical signal 7 results in corresponding variation in the frequency of the sonic energy being applied to the substrate 13 via the elongate probe transmitter 11.

Depending on the exact type of substrate 13 being cleaned, the type of devices on the substrate's 13 top surface, and/or the particles thereon, the desired variation in frequency can be sweeping and/or jumping. Sweeping the frequency of the sonic energy is a gradual or incremental change in the frequency from a first frequency value to a second frequency value. In some embodiments, the frequency sweeping will further comprise gradually or incrementally changing the frequency back and forth between the first frequency value and the second frequency value. The frequency band swept can be of any size and at any frequency value. On the other hand, jumping the frequency of the sonic energy comprises abruptly changing the frequency from a first frequency value to a second frequency value at least once during the cleaning process. The jumping can be an increase and/or a decrease in frequency and can be done as many times as desired.

As mentioned above, the low power and clean signal generation aspects of the present invention can be carried out and incorporated into almost any style of substrate cleaning system.

Referring now to FIGS. 11-18, a number of megasonic cleaning systems that can be used in accordance with the present invention are schematically illustrated. These cleaning systems are illustrated to exemplify the location of the areas of these systems that correspond to the areas of the cleaning system 100 on which power density can be based. Like surfaces and like elements of the cleaning systems of FIGS. 11-18 are numbered identical to corresponding surfaces and elements of the cleaning system 100 with the addition of alphabetic suffixes. A detailed discussion of the cleaning systems 100A-100I will be omitted with the understanding that any and/or all of the details and aspects discussed above with respect to cleaning system 100 are applicable and/or can be incorporated therein as desired.

Finally, it should be noted that the power characteristics of sonic energy created by the transducer can be altered/dampened prior to reaching the transmitter (and subsequently the substrate) by adding transmission layers therebetween. Such modifications do not remove such systems and/or methods from the scope of the present invention and the claims are intended to cover such embodiments.

### Experimental

In addition to the experiments discussed above, an additional front end of the line (“FEOL”) experiment was performed using a Goldfinger single wafer cleaning system designed and built by Akrion, Inc. Details of the Goldfiner system's construction can be found in U.S. Pat. No. 6,140,744, to Bran, the entirety of which is hereby incorporated by reference. The Goldfinger megasonic system was operated at about 1 MHz. The sonic energy was controlled and applied using the clean signal generation and amplification hardware discussed above with respect to system 100 to generate “low power and clean” electrical signals to create “low power and clean” sonic energy that was applied to the surface of semiconductor wafers. 200 mm bare silicon wafers contaminated with Si3N4 particles were used to determine particle removal efficiency (PRE) while 300 ETCxxx wafers (also 200 mm and prepared by Sematech) were used for the damage testing. These wafers had 1500 m poly silicon on 25 O Si02 patterns.

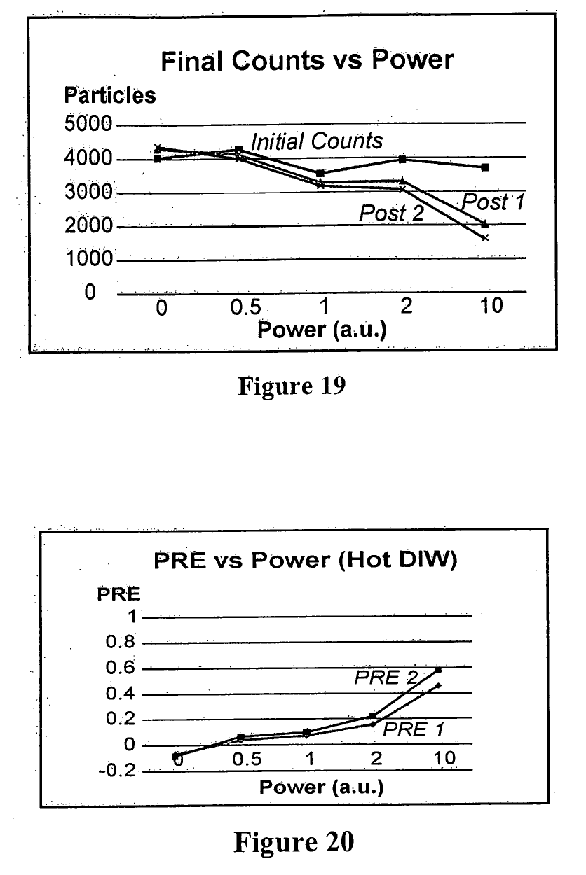

The results of the FEOL experiment using DIW at about 60° C. are shown in FIG. 19 where PRE is plotted against power in arbitrary units (“a.u.”), and in FIG. 20 where particle final count is plotted against power. As can be seen from FIGS. 19 and 20, particle removal increases with applied power to the transducer.

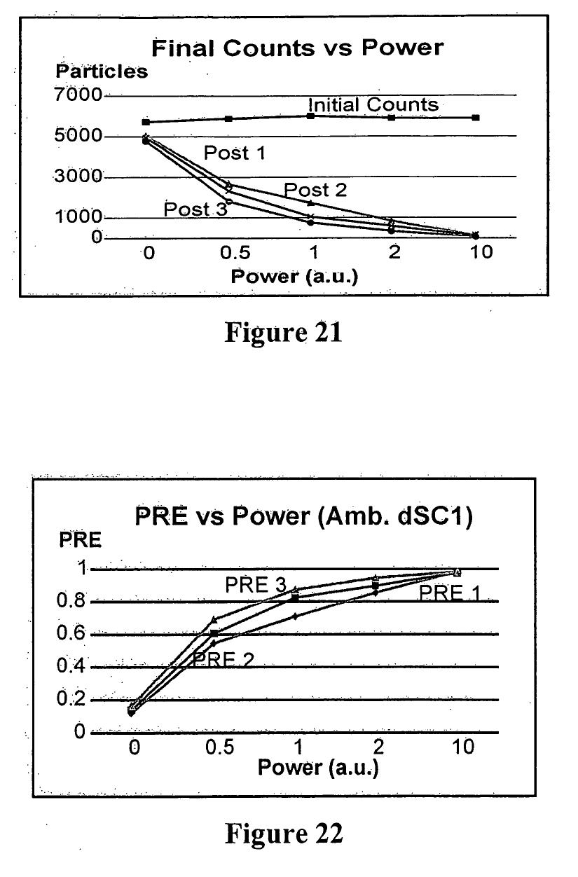

The FEOL experiment was also performed using ambient ultra dilute SCI. Referring to FIGS. 21 and 22, the FEOL experiment using ultra dilute SCI resulted in a similar trend for power vs. particle removal (PRE and particle final count). However, the use of ultra dilute SC1 resulted in a much higher particle removal.

While not illustrated graphically, much higher PRE was obtained at higher power levels greater than 10 a.u. but resulted in an increase in the number of damage sites on the patterned wafers. Thus, the power (density) of the sonic energy was reduced significantly to produce high PRE and zero damage. However even with such low power density levels, occasional damages sites were observed indicating that the cleaning systems was not robust enough to warrant damage-free high particle cleaning systems consistently.

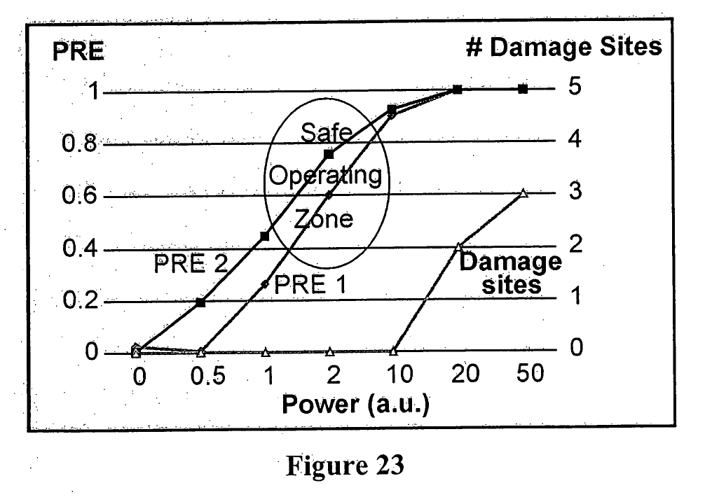

As a result, focus was shifted to optimize the cleaning process in order to obtain the highest possible PRE and zero damage. This was achieved by redesigning the megasonic cleaning systems to produce the “best conditioned” (i.e., clean) signal as described above. Use of the clean signal to power the transducer prevented energy spikes and noise that was shown to be responsible for the damage of the delicate structures. The experiment was continued under these conditions and the results are shown in FIG. 23. FIG. 23 plots the PRE and damage sites against the sonic energy level for the dilute SC1 system. Except for differences in PRE, similar damage free cleaning resulted when DIW was used instead of dSCI (the DIW experiment is shown in FIGS. 7-10).

The results prove that low power sonic energy and conditioned acoustic waves at about 1 MHz are keys to produce such results. Megasonic systems continue to show that satisfactory results can be obtained but require great attention as to how the acoustic energy is applied to the wafer surface.

While the invention has been described and illustrated in sufficient detail that those skilled in this art can readily make and use it, various alternatives, modifications, and improvements should become readily apparent without departing from the spirit and scope of the invention.

What is claimed is:

1. A method of cleaning substrates comprising:
(a) providing a source of sonic energy;
(b) supporting a substrate;
(c) applying cleaning fluid to at least a first surface of the substrate;
(d) creating sonic energy having a power density less than 12.5 Watts per cm²; and
(e) applying the sonic energy to the substrate while applying the cleaning fluid to the first surface for a predetermined time so as to loosen particles on the first surface.

2. The method of claim 1 wherein the power density is based on the area of the first surface of the substrate, and step (d) comprises creating sonic energy having a power density less than 12.5 Watts per cm² of the area of the first surface.

3. The method of claim 1 further:
wherein step (c) comprises applying a layer of cleaning fluid on the first surface of the substrate;
wherein the source of sonic energy comprises a transmitter operably coupled to a transducer, the transmitter being in contact with the layer of cleaning fluid so that a surface area of the transmitter is in contact with the layer of cleaning fluid;
wherein step (d) comprises creating sonic energy having a power density less than 12.5 Watts per cm 2 of the surface area of the transmitter that is in contact with the layer of cleaning fluid; and
wherein step (e) comprises the transmitter transmitting the sonic energy through the layer of cleaning fluid and to the substrate.

4. The method of claim 3 wherein the transmitter comprises an elongated edge in contact with the layer of cleaning fluid and the substrate is supported in a substantially horizontal orientation, the method further comprising creating relative motion between the substrate and the transmitter so that the sonic energy is applied to the entire first surface.

5. The method of claim 1 further:
wherein the source of sonic energy comprises a transmitter operably coupled to a coupling area of a transducer, the transmitter in contact with the cleaning fluid;
wherein step (d) comprises supplying electrical energy to the transducer at a power level that results in the power density level being less than 12.5 Watts per cm 2 of the coupling area of the transducer, the transducer converting the electrical energy into corresponding sonic energy, the sonic energy being transmitted to the transmitter through the coupling area; and
wherein step (e) comprises the transmitting the sonic energy to the substrate via the transmitter.

6. The method of claim 1 wherein the power density is within the range of 0.01 to 12.5 Watts per cm².

7. The method of claim 6 wherein the power is within the range of 0.01 to 2.5 Watts per cm².

8. The method of claim 6 wherein the power is within the range of 1 to 4 Watts per cm².

9. The method of claim 1 wherein the predetermined time is within the range of 20 to 70 seconds.

10. The method of claim 1 wherein the predetermined time and the power density are selected so as to remove at least 80% of particles from the first surface of the substrate upon completion of step (e).

11. The method of claim 10 wherein the predetermined time is approximately 30 seconds, the power density is approximately 0.2 watts/cm², and approximately 80% of particles are removed from the first surface of the substrate, and wherein the cleaning fluid is an ambient standard clean 1 (“SC1”) solution.

12. The method of claim 11 wherein the ambient SC 1 solution comprises approximately 1 part NH40H: 2 parts H202: x parts H₂O, where 100<x<500.

13. The method of claim 1 further:
wherein step (c) comprises forming a layer of cleaning fluid on the first surface of the substrate, the first surface of the substrate being a device side;
wherein the source of sonic energy comprises a transmitter having an elongated edge, the elongate edge of the transmitter being coupled to the layer of cleaning fluid on the device side of the substrate; and
wherein step (e) comprises transmitting the sonic energy to the device side of the substrate through the layer of cleaning fluid via the trasnmitter.

14. The method of claim 1 wherein the source of sonic energy comprises an elongated probe transmitter, and wherein 40 Watts or less of sonic energy is delivered to the elongate probe.

15. The method of claim 1 wherein step (d) wherein the sonic energy has a frequency within a range of 800 kHz to 2 MHz.

16. The method of claim 1 further comprising:
(f) varying frequency of the sonic energy during application to the substrate.

17. The method of claim 16 wherein step (f) comprises repetitively sweeping the frequency from a first frequency value to a second frequency value.

18. The method of claim 16 wherein step (f) comprises jumping from a first frequency value to a second frequency value.

19. The method of claim 1 wherein the cleaning fluid is selected from a group consisting of deionized water, gasified deionized water, SC1, dSC1, dilute ammonia, HF, nitric acid, a mixture of sulfuric acid and a polymer/photoresist stripper.

20. A method of cleaning substrates comprising:
(a) supporting a substrate in a substantially horizontal orientation;
(b) applying a layer of cleaning fluid to a first surface of the substrate;
(c) providing a transmitter in contact with the layer of cleaning fluid, the transmitter operably coupled to a transducer, the transmitter provided so that a surface area of the transmitter is in contact with the layer of cleaning fluid;
(d) supplying sonic energy to the transmitter at a power density less than 12.5 Watts per cm² of the surface area of the transmitter that is in contact with the layer of cleaning fluid for a predetermined period of time; and
(e) transmitting the supplied sonic energy through the layer of cleaning fluid and to the substrate via the transmitter, the sonic energy loosening particles on the substrate.

21. The method of claim 20 wherein the first surface of the substrate is a device side.

22. The method of claim 20 wherein the surface area of the transmitter that is in contact with the layer of cleaning fluid is less than an area of the first surface, the method further comprising creating relative motion between the transmitter and substrate so that the sonic energy is transmitted to the entire first surface.

23. The method of claim 20 further comprising the step of:
(f) varying frequency of the sonic energy being transmitted to the substrate.

24. The method of claim 23 wherein step (f) comprises repetitively sweeping the frequency of the sonic energy back and forth between a first frequency value and a second frequency value.

25. The method of claim 23 wherein step (f) comprises repetitively jumping between a first frequency value and a second frequency value.

26. A method of cleaning substrates comprising:
(a) supporting a substrate in a process chamber;
(b) providing a cleaning fluid on a first surface of the substrate;
(c) providing a transmitter in contact with the cleaning fluid, the transmitter operably coupled to a coupling area of a transducer;
(d) supplying electrical energy to the transducer at a power level that results in a power density that is less than 12.5 Watts per cm 2 of the coupling area of the transducer for a predetermined time; and
(e) the transducer converting the electrical energy into corresponding sonic energy, the sonic energy being transmitted to the transmitter through the coupling area; and
(f) transmitting the sonic energy through the cleaning fluid and to the substrate, the sonic energy loosening particles on the substrate.

27. A system for processing substrates comprising:
a support for supporting at least one substrate in a substantially horizontal orientation;
means for creating an electrical signal;
a transducer operably coupled to the signal creation means, the transducer adapted to receive an electrical signal created by the signal creation means and convert said electrical signal into corresponding sonic energy;
means for supplying a layer of fluid to at least a first surface of a substrate positioned on the support;
a transmitter operably coupled to the transducer, the transmitter in contact with the layer of fluid to apply sonic energy created by the transducer to a substrate positioned on the support;
a controller operably coupled to the signal creation means, the controller programmed to control the signal creation means so that the electrical signal created results in the corresponding sonic energy having a power density less than 12.5 Watts per cm².

28. The system of claim 27 wherein the power density of the sonic energy is based on the area of the first surface of the substrate, a surface area of the transmitter that is contact with the cleaning fluid, or a coupling area of the transducer.

29. The system of claim 27 wherein the transmitter comprises an elongate edge and the system further comprises a means for creating relative motion between the substrate and the transmitter.
